(19) United States
(12) Patent Application Publication
(10) Pub. No.: US 2017/0178088 A1
(43) Pub. Date: Jun. 22, 2017

(54) PERFORMING A TICKETING OPERATION

(71) Applicant: AUTORITAT DEL TRANSPORT METROPOLITÁ, BARCELONA (ES)

(72) Inventors: Maria Del Carmen FÁBREGAS CASAS, BARCELONA (ES); Jordi TIRADO MORAGA, CORNELLÀ DE LLOBREGAT (ES); Daniel FERNÁNDEZ CASANELLAS, CORNELLÀ DE LLOBREGAT (ES)

(21) Appl. No.: 15/308,805

(22) PCT Filed: May 6, 2014
(86) PCT No.: PCT/EP2014/059160

§ 371 Date: Nov. 3, 2016

(51) Int. Cl. G06Q 20/04; H04L 29/06; H04W 12/04; H04L 9/00

(52) U.S. Cl. CPC G06Q 20/045; H04L 9/00; H04L 63/04; H04L 63/06; H04L 63/08; H04W 12/04; G06Q 20/04; G06Q 2220/00

(57) ABSTRACT

Methods of performing a ticketing operation between a ticketing terminal and a user device having a device configuration are provided. The ticketing terminal comprises a terminal module, and the user device comprises a memory having one or more data blocks/files each having one or more data fields. The method comprises identifying the device configuration, and retrieving at the terminal module one or more abstract instructions of access to the user device for performing the ticketing operation. The method further comprises retrieving from a secure module one or more specific instructions of access to the user device for performing the abstract access instructions, and performing the abstract access instructions by executing the specific access instructions. Ticketing terminals suitable for carrying out said methods are also provided.

The present disclosure relates to methods of performing a ticketing operation between a ticketing terminal and a user device, and to ticketing terminals adapted to carry out such methods.

### BACKGROUND

A ticketing operation may be defined as an operation or transaction aimed at (potentially) enabling a user to access a service which is normally subjected to some kind of payment. A typical example may be transport ticketing in which a plurality of users may interact with ticketing terminals for gaining access to a (e.g. public) transport medium, such as a bus, a train, or any other transport medium.

In the case of transport ticketing, for example, different types of terminals may be suitably placed and configured to carry out different ticketing operations, such as e.g. recharging of a transport card, validation for gaining access for one or more trips, etc. A ticketing operation may comprise e.g. a corresponding request from a user device (e.g. a smart card or a mobile phone) to the terminal for requesting such a type of operation, one or more accesses by the terminal to the user device to check that necessary conditions are satisfied, a payment transaction, updating of one or more fields in the user device (e.g. a field containing the number of available trips), etc.

In some special cases, “privileged” people such as e.g. at least some pensioners, may be liberated from paying for gaining access to e.g. public transportation. In these particular situations, payment for obtaining the right of accessing to the service (e.g. a bus) may not be required. Instead, such people may own some kind of (e.g. pensioner) accreditation implemented in their user device indicating that payment is not required. Different kinds of discounts may also be possible.

Known ticketing systems (including ticketing terminals) and methods are typically restricted to a particular type of card (or user device) having a particular configuration. This particular configuration may include a particular location of data fields in a memory of the user device, a particular definition (or implementation) of security aspects in the card, etc. This may therefore cause the overall ticketing system to be excessively dependent on a particular user device type/configuration chosen, which may limit its evolution.

Moreover, security may not be suitably ensured because hackers or security attackers may determine how this single configuration is implemented, e.g. where different data fields are stored and used. This way, fraud may proliferate along an entire ticketing network in such a way that large losses may be caused by corresponding hackers or attackers. In some particular systems, all or almost all the ticketing terminals have had to be replaced by new terminals due to security attacks or fraud of the mentioned type.

Another problem of existing ticketing systems or terminals may be that, as commented above, security aspects are normally implemented in the user device itself. These security aspects may be based on e.g. having files or data blocks in the user device protected through one or more cryptographic keys, such that data fields are usually grouped depending on said keys and not depending on functionality aspects. This may make at least some ticketing operations inefficient because several accesses to several files or blocks with different keys may be required for performing a particular operation.

Ticketing operations are normally performed by ticketing terminals by executing access instructions on the user device which are dependent on the particular type and/or configuration chosen for the user device. These access instructions are typically defined (stored) in a memory in the terminal which may be accessible by hackers or attackers such that they may determine how ticketing operations are implemented. Once an attacker has discovered how an operation is implemented, proliferation of fraud may also be in this case unavoidable which may cause large loses for the (e.g. transport) company.

### SUMMARY

The present disclosure provides methods of performing a ticketing operation between a ticketing terminal and a user device, and ticketing terminals adapted to carry out such methods, said methods and terminals solving at least some of the aforementioned problems.

In a first aspect, a method of performing a ticketing operation between a ticketing terminal and a user device is provided. The user device has a device configuration, the ticketing terminal comprises a terminal module, and the user device comprises a memory having one or more data blocks each having one or more data fields. The method comprises identifying the device configuration, and retrieving at the terminal module one or more abstract instructions of access to an abstract user device for performing the ticketing operation. The method further comprises retrieving from a secure module one or more specific instructions of access, depending on the identified device configuration, to the user device for performing the abstract access instructions. The method still further comprises performing the abstract access instructions by executing the specific access instructions and thereby performing the ticketing operation.

Herein, the expression “(user) device configuration” may be defined as physical and logical aspects that may characterize the way(s) of accessing the user device. A physical aspect may be that e.g. the user device comprises a memory of a certain size. A logical aspect may be that e.g. said memory is structured according a given logical organization with e.g. a certain number of data files/blocks. A skilled person may thus appreciate that the type of the user device (e.g. smart card, mobile phone, etc.) and how it is configured may condition how data contained in the user device can be accessed. Therefore, the expression “(user) device configuration” will be used herein for globally referring to all or most of these physical/logical aspects.

The memory of the user device may comprise data blocks (as mentioned before), data files, or any other type of data organization aimed at storing data in a structured manner. Herein, the expression “data block” will be used for globally referring to any element similar to data blocks/files, i.e. aimed at storing data in a structured way.

The abstract access instructions may refer to access instructions that are independent of the configuration of the user device, i.e. for accessing to an abstract user device. These abstract access instructions may thus refer to abstract rules, actions, commands, etc. which may refer to performing an abstract operation on e.g. abstract data fields in the user device irrespective of e.g. where corresponding data is stored in the user device's memory. For instance, in a transport ticketing application, an abstract access instruction may refer to e.g. accessing an abstract field representing e.g. the number of available trips, which may be physically stored in e.g. one or more physical fields depending on the type/configuration of the user device.

The specific access instructions may refer to access instructions that are dependent on the device configuration. These specific access instructions may therefore refer to specific rules, actions, commands, etc. which may refer to performing a specific operation on e.g. physical data fields physically stored in the user device's memory. One abstract access instruction may thus be implemented by one or more specific access instructions. For example, an access to an abstract field may comprise a number of accesses to the user device depending on the configuration of the user device.

In a particular user device, one abstract access instruction may cause execution of e.g. several specific access instructions, such as e.g. an initial authentication between the terminal and the user device, a first access to particular files or blocks in the memory of the user device, other accesses to particular positions or physical fields in said files or blocks, etc. In other types (or configurations) of user devices, the aforementioned initial authentication may not be required, so, in this case, one abstract access instruction may comprise fewer specific access instructions to be executed in the corresponding user device.

The user device may be any device configured to communicate with the ticketing terminal and suitably store data depending on the intended application (e.g. transport ticketing application). This communication may be contactless (based on e.g. RFID communications) or not (based on e.g. reading/writing a magnetic stripe). In the former case, the user device may thus preferably be a contactless device such as e.g. an NFC smart card, a mobile phone, etc.

The secure module may refer to a module which is protected against external attacks aimed at extracting information (i.e. data) from the inside of the module and at modifying the behaviour of the module. Secure Access Modules (SAM) and Hardware Security Modules (HSM) are examples of secure modules.

The secure module may be hardware and/or software implemented. The secure module may comprise more than one (sub) modules configured to operate together in such a way that protection against external attacks is substantially ensured.

A mapping between abstract and specific data and between abstract and specific instructions may be defined in the secure module (e.g. stored in a memory of the secure module). This way, the secure module may produce corresponding specific instructions for accessing specific data (in the user device) depending on the device configuration for suitably implementing abstract instructions for accessing abstract data requested by the terminal module.

The terminal module may therefore be seen as storing an abstract logic (independent of the user device) implementing ticketing operations and the secure module as storing a specific logic (dependent on the user device) implementing said abstract logic depending on the configuration of the user device.

The terminal module may be hardware and/or software implemented. The terminal module may comprise more than one (sub) modules configured to operate in unison for providing the corresponding functionalities. For example, the terminal module may comprise a (sub) module for communicating with the user device, a (sub) module for retrieving abstract access instructions, etc.

An aspect of using abstract instructions, which are accordingly “translated” by the secure module into specific instructions, may be that ticketing operations may be performed (between the ticketing terminal and the user device) in a more secure manner. Since the specific access instructions (dependent on the user device) are provided by the secure module, it can be significantly complex (potentially impossible) for an attacker to determine how and where data is stored in the user device, as well as how this data is processed by the ticketing terminal. Hence, the risk of fraudulent attacks may be relatively minimized.

A further aspect of the proposed “ticketing” method may be that a diversity of user devices of different types and having different configurations (e.g. different structures of data stored in the user device's memory) may be easily integrated in a ticketing system. In other words, a same ticketing terminal may be used with heterogeneous user devices by simply implementing the necessary specific access instructions corresponding to each different type/configuration of (heterogeneous) user devices. Consequently, a versatile ticketing system may be provided such that it is not restricted to a particular technology of the user device.

New types of user devices (having new configurations) may thus be easily incorporated to a ticketing system (i.e. corresponding terminals). This may be achieved by simply incorporating new corresponding specific access instructions (depending on the new device configuration) to the secure module. This way, corresponding abstract access instructions, which are invariable in the sense that they are independent of the user device, may be suitably performed by executing said added (incorporated) specific access instructions.

Another aspect of using abstract instructions to be accordingly “translated” by the secure module into specific instructions may be that at least some specific access instructions may be configured based on one or more specific access conditions dependent on the device type/configuration. Examples of access conditions may be: performing a previous authentication for accessing to particular files or data blocks, providing a cryptographic key to be validated by the user device for accessing to particular files or data blocks, etc.

These specific access conditions may vary depending on each different device type/configuration and may implement security aspects (e.g. authentication, use of cryptographic key(s), etc.). Main security aspects may therefore be centrally defined (along with specific access instructions) at the secure module side, such that abstract access instructions may be defined at the terminal module side without including security aspects. This may provide a relatively stronger security, “isolated” or independent from security aspects implemented in the user devices. Hence, simpler and cheaper user devices without complex security arrangements or rules may be used for performing ticketing operations with the ticketing terminal.

In examples of the method, one or more of the specific access conditions may be defined at the level of data field, since, as commented before, the security of the ticketing operations may be defined at the secure module side irrespective of security aspects defined in the user devices. An aspect of this feature may be that specific access instructions may be obtained (or retrieved) and sent to the user device for accessing just a single field, even though more than one fields may be accessed by suitably configured specific access instructions. This possibility of accessing to just a single field depending on e.g. particular access conditions (which may include e.g. security conditions) may permit defining a more rational location of data fields in files (or data blocks) in the user device's memory.

In prior art user devices intended for ticketing operations (such as e.g. smart cards), security aspects are typically defined in the card itself. For example, the memory of the card may comprise files protected with a cryptographic key and fields not protected with a key. Taking this into account, sensitive data may be normally located in protected files, such that data about heterogeneous functional aspects may be stored in the same file, which may be contrary to the logic to be followed by certain ticketing operations.

With the proposed solution based on having access conditions (i.e. security conditions) defined in the secure module at the level of data field, different fields with different access conditions may be stored in the same file or data block in the user device. Data referring to a same functional aspect (or process, or operation) may therefore be stored in the same file instead of having data fields grouped depending on security (access) conditions although they are functionally unrelated. Accordingly, ticketing operations may be defined (in terms of specific access instructions) more efficiently, since a smaller number of accesses may be required due to the fact that data may be grouped in files according to functional (process oriented) criteria.

Taking the above into consideration, one or more of the specific access conditions may comprise using a cryptographic key to be validated for accessing to a corresponding (single) data field. In particular, using the cryptographic key may comprise signing at least part of the corresponding specific access instruction with the cryptographic key, and/or an authentication based on the cryptographic key.

Alternatively or additionally, the cryptographic key may be the same cryptographic key for accessing to different data fields of different data blocks/files of the user device's memory. More particularly, the cryptographic key may be the same cryptographic key for accessing to any data field of any data block/file of the user device's memory. In other words, just a single cryptographic key may be defined for performing accesses to different fields in different blocks or files in the user device's memory.

Since access conditions, including security logic (or rules, or conditions, or aspects, etc.), may be defined at the side of the secure module, they may be (re)defined as many times as necessary. When, for example, a fraud is detected, it may be easily solved by (re)defining the corresponding security conditions (at the secure module side) in such a way that fraudulent operations may be properly disabled, probably for a short time.

In some implementations, one or more of the specific access conditions may comprise encrypting at least partially the corresponding specific access instruction(s). With this feature, security of the overall system may be increased even more, since specific access instructions may be interchanged between the terminal and the user device encrypted (i.e. protected).

In examples of the method, identifying the device configuration may comprise the terminal module receiving from the user device an identifier of the user device, and the terminal module sending the identifier to the secure module for the secure module to identify the device configuration. Once the secure module has identified the device configuration, it may obtain or retrieve corresponding specific access instructions depending on said identified configuration.

According to implementations of the method, retrieving the abstract access instructions at the terminal module may comprise the terminal module retrieving the abstract access instructions according to one or more abstract ticketing rules. These abstract ticketing rules may refer to rules independent of the device configuration.

These abstract ticketing rules may be implemented in the form of e.g. an algorithm configured to generate (or retrieve) corresponding abstract access instructions (independent of device configuration). This algorithm may be based on e.g. logic to be followed for completing the corresponding ticketing operation. Each different ticketing operation may have its own logic implementing the ticketing operation. Said logics may comprise e.g. validations and necessary accesses to the user device for said validations, decision steps depending on the results of said validations, (read/write) accesses to the user device depending on e.g. said decision steps, loops, etc.

As a result, the execution of the abovementioned abstract logic may finally produce corresponding abstract access instructions defining which accesses to abstract fields are required to complete the ticketing operation.

According to some examples, the abstract access instructions may be comprised in a single set of abstract access instructions, such that the terminal module retrieving the abstract access instructions may comprise the terminal module retrieving the abstract access instructions from said single set of abstract access instructions. As the abstract access instructions may be independent of the (user) device configuration, just a single set of abstract instructions for each ticketing operation may be defined at the terminal module.

This single set of abstract access instructions may be stored in a memory associated to the terminal module in such a way that the terminal module may obtain them from said memory. This memory may be e.g. comprised in the terminal module.

In implementations of the method, retrieving the specific access instructions from the secure module for performing the abstract access instructions may comprise the terminal module sending to the secure module the abstract access instructions and receiving from the secure module the corresponding specific access instructions. Once the secure module has identified the device configuration and has received the abstract access instructions, the secure module may retrieve the corresponding specific access instructions depending on the device configuration and the abstract access instructions to be performed.

Retrieving of the specific access instructions may be performed by the secure module in such a way that their execution may cause performance of the abstract access instructions requested by the terminal module.

The specific access instructions may be comprised in a set of specific access instructions of a plurality of sets of specific access instructions, each of said sets being dependent on a different device configuration. Consequently, the secure module retrieving the specific access instructions may comprise the secure module determining the set of specific access instructions depending on the device configuration, and the secure module retrieving the specific access instructions from said set of specific access instructions.

A different set of specific access instructions may thus be defined or stored in the secure module for each different device configuration with which the terminal may interact for completing ticketing operations. A one-to-many relationship may therefore be defined between the set of abstract instructions and the plurality of sets of specific instructions. This means that a single abstract instruction may be performed in different ways (i.e. by executing different specific instructions) depending on the device configuration.

In examples of the method, performing the abstract access instructions by executing the specific access instructions may comprise the terminal module performing four steps. One of said steps may comprise the terminal module sending to the user device the specific access instructions for the user device to produce corresponding responses to the specific access instructions. Another one of said steps may comprise the terminal module receiving from the user device the responses to the specific access instructions. A further step of said steps may comprise the terminal module sending to the secure module the responses to the specific access instructions for the secure module to produce corresponding responses to the abstract access instructions based on at least some of the responses to the specific access instructions. A still further step of said steps may comprise the terminal module receiving from the secure module the responses to the abstract access instructions.

For the sake of simplicity, the terminal module may be seen as a “bridge” between the ticketing terminal and the user device when performing the abovementioned four steps. Once the secure module has determined the specific access instructions to be executed in the user device for performing the corresponding abstract access instructions, an interaction between the terminal and the user device may be carried out for completing the specific access instructions. In this interaction between the terminal and the user device, the terminal module may thus be seen as acting as an intermediary passing data (instructions and corresponding responses) between the terminal and the user device.

Once the secure module has received the corresponding responses to the specific access instructions from the user device (through the terminal module acting as a “bridge”), the secure module may construct/obtain the corresponding responses to the abstract access instructions (requested by the terminal module to the secure module) from said received responses to the specific access instructions.

In a second aspect, a ticketing terminal is provided which is configured to perform any of the previously described methods of performing a ticketing operation. Aspects/advantages commented with respect to said methods may therefore also be attributed to this ticketing terminal.

In some examples of ticketing terminals, the secure module may comprise a secure access module (SAM). Alternatively or additionally, the secure module may comprise a hardware security module (HSM).

In some configurations, the secure module may be either remote or local to the ticketing terminal. In the case of being remote, a suitable connection between the secure module and the terminal may exist. This connection may be implemented through e.g. a communications network, such as e.g. Internet. This connection may be a secure connection.

In some of the implementations wherein the secure module is local to the terminal, a (further) remote secure module may be connected with the ticketing terminal such that both the local and remote secure modules can operate together. Such a connection may be implemented through e.g. a communications network, such as e.g. Internet. This connection may be a secure connection.

An aspect of having a local and a remote secure module may be that the ticketing terminal may have an increased security. Critical specific access instructions may be obtained from the remote secure module in order to make difficult for an attacker to access their definition/implementation stored/defined in the remote secure module. Non-critical specific access instructions may be obtained from the local secure module in order to permit the terminal to operate faster.

Critical specific access instructions may be e.g. those which involve some payment, accounting of money, reconfiguration of the user device's memory, etc. Non-critical specific access instructions may be e.g. those which only involve some query, such as e.g. a query of the number of available trips.

Another aspect of having a local and a remote secure module may be that interruption of the operation may be avoided when a loss of communications between the remote secure module and the terminal occurs. In this sense, the local secure module may be configured to assume functionalities normally attributed to the remote secure module when a loss or deficiency in communications is detected. The local secure module may have associated e.g. a limit of ticketing operations the terminal can perform in order to prevent a “large” number of frauds. This limit may be provided by the remote secure module periodically or under request by the terminal, for example.

### BRIEF DESCRIPTION OF THE DRAWINGS

Non-limiting examples of the present disclosure will be described in the following, with reference to the appended drawings, in which:

FIG. 1 is a block diagram representing a ticketing terminal according to a first example, and a user device configured to communicate with the ticketing terminal for performing ticketing operations together;

FIGS. 2a and 2b are block diagrams representing other possible configurations according to respective examples alternative to the example shown in FIG. 1;

FIG. 3 is a flow chart representing a method of performing a ticketing operation according to an example.

### DETAILED DESCRIPTION OF EXAMPLES

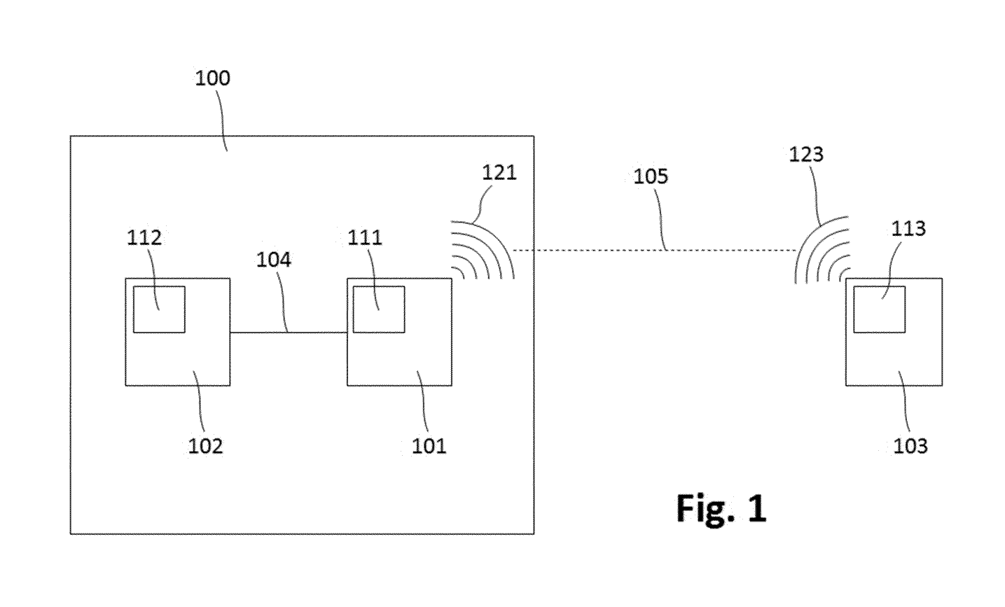

FIG. 1 is a block diagram representing a ticketing terminal 100 according to a first example, and a user device 103 configured to communicate with the ticketing terminal 100 for performing ticketing operations together. The ticketing terminal 100 is shown comprising a terminal module 101 and a secure module 102. A user device 103 is also shown which may have a particular device configuration.

The terminal module 101 may be configured to emit/receive electromagnetic signals 121. The user device 103 may be configured to emit/receive electromagnetic signals 123. A wireless non-contact communication channel 105 may thus be established between the terminal module 101 and the user device 103 through said electromagnetic signals 121, 123. This channel 105 may be based on RFID technology, for example.

The terminal module 101 and the secure module 102 are shown connected through a suitable connection 104, such that data can be interchanged between said modules 101, 102.

The terminal module 101 is shown comprising a memory 111 which may store abstract ticketing rules (or algorithms) for generating corresponding requests of abstract access instructions (which may be independent of the device configuration) to be sent to the secure module 102 through the connection 104.

The secure module 102 is shown comprising a memory 112 which may store a definition/implementation of the abstract access instructions in the form of specific access instructions (which may be dependent on the device configuration). The secure module 102 may thus translate each set of abstract access instructions received from the terminal module 101 into corresponding specific access instructions.

The user device 103 is shown comprising a memory 113 which may store necessary (user) data for performing ticketing operations with the ticketing terminal 100. Data stored in the memory 113 may be structured in a variety of manners. For example, the memory 113 may comprise one or more files or data blocks each comprising data fields grouped according to functional criteria. At least some of said files may be protected through one or more corresponding cryptographic keys.

The memory 112 of the secure module 102 may also store access conditions associated to specific access instructions depending on the device configuration. Said access conditions may comprise security conditions, such as e.g. whether a data field in the user device has to be accessed by using a cryptographic key or not. These access conditions defined at the side of the secure module may permit using simpler user devices for performing ticketing operations, since security aspects may not be defined at the side of the user device.

Having security conditions defined at the side of the secure module 102 may also permit having a single cryptographic key “protecting” all or most of the data fields in the memory 113 of the user device 113. This feature may simplify implementations of ticketing operations.

The memory 111 of the terminal module 101 may store just a single set of requests to abstract access instructions (independent of the device configuration). The memory 112 of the secure module 102 may store a plurality of sets of specific access instructions (dependent on the device configuration) each implementing the single set of abstract access instructions. This may make the terminal to be capable of performing ticketing operations with different user devices having different configurations.

The abstract rules and instructions stored in the memory 111 of the terminal module 101 may be hardware and/or software implemented. The specific instructions (and corresponding access conditions) stored in the memory 112 of the secure module 102 may also be hardware and/or software implemented. All or some of the software implementations may comprise e.g. an implementation in a corresponding assembler language in such a way that the terminal may operate faster.

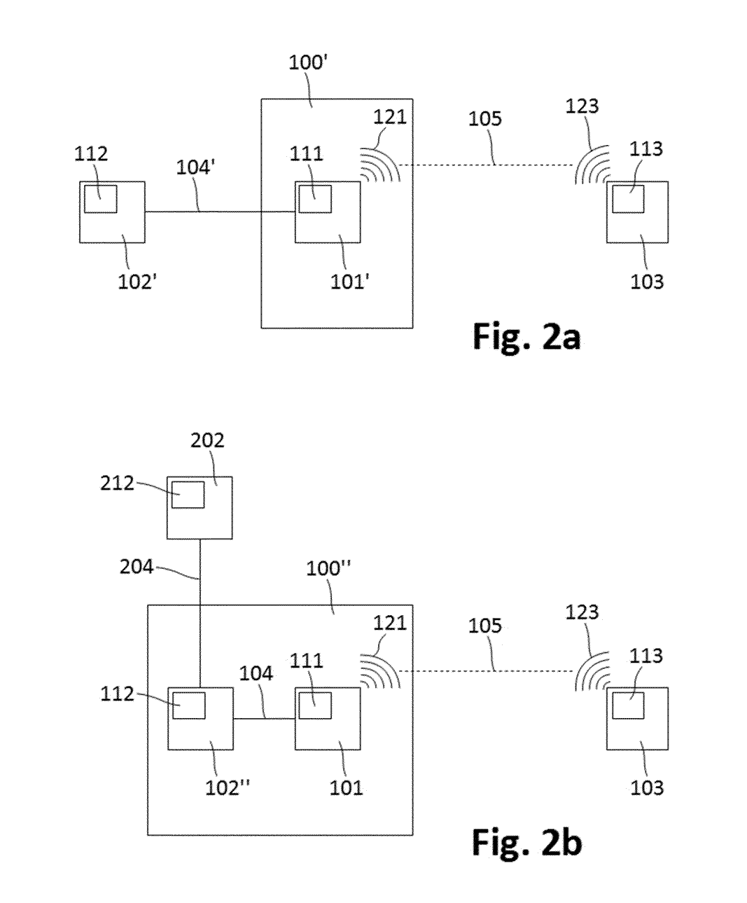

FIG. 2a is a block diagram representing another configuration according to an example alternative to the example of FIG. 1. In this particular case, the secure module 102′ is shown remote to the ticketing terminal 100′. The remote secure module 102′ and the terminal module 101′ are shown connected through a suitable connection 104′ which may be implemented through a communications network such as e.g. Internet. This communication 104′ may be a secure communication.

FIG. 2b is a block diagram representing another configuration according to an example alternative to the examples of FIGS. 1 and 2a. In this particular case, a further secure module 202 (which is remote to the terminal 100″) is shown connected with the secure module 102″ (which is local to the terminal 100″) through a suitable connection 204. This connection 204 may be implemented through a communications network such as e.g. Internet. This communication 204 may be a secure communication.

Still with reference to FIG. 2b, the local secure module 102″ and the remote secure module 202 may be configured to operate together in such a way that required “secure” functionalities may be equally or similarly provided. The remote secure module 202 is shown comprising a corresponding memory 212. The remote and local secure modules 102″, 202 may thus provide the same or similar functionalities to those provided by the secure module 102 and 102′ in FIGS. 1 and 2a.

An aspect of having said remote and local secure modules 102″, 202 may be that critical functionalities may be provided by the remote secure module 202 and non-critical functionalities may be provided by the local secure module 102″. This approach may therefore provide an increased security to the overall system. Furthermore, the local secure module 102″ may be configured to provide functionalities normally provided by the remote secure module 202 in case of loss or some deficiency in the communication 204 between them.

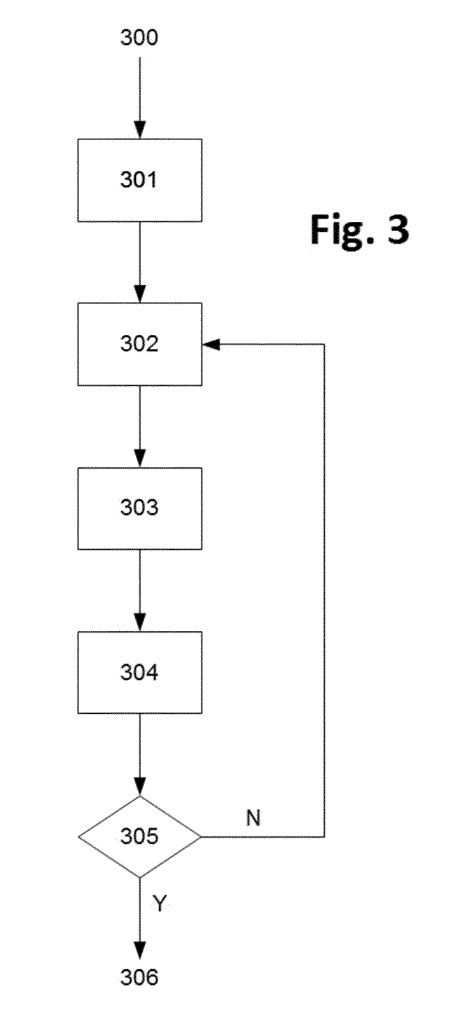

FIG. 3 is a flow chart representing a method of performing a ticketing operation according to an example. This particular method will be discussed also with reference to the system(s) shown in FIG. 1. The method may be initiated when an initial event 300 occurs, which may be the simple presence of the user device 103 within the operational field of the terminal module 101, such that a wireless connection 105 between terminal 100 and user device 103 may be established.

At the step 301, the terminal module 101 may receive an identifier from the user device 103 through the connection 105, such that the configuration of the user device 103 may be identified. This identification of the device 103 configuration may be performed by the terminal module 101 relaying, through the connection 104, the received identifier to the secure module 102 for the secure module 102 to identify the device 103 configuration.

At step 302, once the device 103 configuration has been identified (by the secure module 102), the terminal module 101 may retrieve or request corresponding abstract access instructions (independent of the device 103 configuration) from its memory 111 to perform at least part of the ticketing operation. Abstract access instructions may be determined according to abstract rules or algorithms which may also be stored in the memory 111 of the terminal module 101. Rules or algorithms may represent a logic flow necessary for performing the ticketing operation.

Still at step 302, once the terminal module 101 has determined/obtained which (request of) abstract access instructions may be performed for performing at least part of the ticketing operation, the terminal module 101 may send them to the secure module 102.

At step 303, once the secure module 102 has received the abstract access instructions from the terminal module 101, the secure module 102 may determine/retrieve from its memory 112 the necessary specific access instructions (dependent on the device 103 configuration) for carrying out the received abstract access instructions. The secure module 102 may have stored in its memory 112 different sets of specific access instructions for different device configurations. The secure module 102 may therefore select that set of specific access instructions which are applicable to the particular configuration of the user device 103. Once said set has been selected, the secure module 102 may then determine/retrieve the necessary specific access instructions from said set.

At step 304, the secure module 102 may cause execution of the retrieved specific access instructions in the user device 103 and receive corresponding responses from the user device 103. This interaction between the secure module 102 and the user device 103 may be performed with the terminal module 101 acting as a “bridge” between the secure module 102 and the user device 103.

Said intervention of the terminal module 101 as a “bridge” may comprise the terminal module 101 receiving from the secure module 102 the specific access instruction(s) and sending them to the user device 103 for the user device 103 to produce corresponding responses to said specific access instruction(s). Said “bridge” intervention may further comprise the terminal module 101 receiving from the user device 103 said responses to the specific access instructions, and sending them to the secure module 102 for the secure module 102 to produce corresponding responses to the abstract access instructions based on said responses to the specific access instructions.

Once the terminal module 101 has received from the secure module 102 said responses to the abstract access instructions, the terminal module 101 may determine, at step 305, whether the ticketing operation has been completed or not. If the ticketing operation has been completed, the method may be ended at final step 306. If the ticketing operation has not been completed, the method may loop back to step 302 for the terminal module 101 to generate/retrieve new abstract access instructions necessary for advancing in the performance of the ticketing operation.

Several iterations of the loop constituted by steps 302-305 may be performed for achieving completion of the ticketing operation. For example, in a first iteration, a first group of (one or more) abstract access instructions may be performed for carrying out an authentication between the terminal 100 and the user device 103. In a second iteration, a second group of (one or more) abstract access instructions may be performed for accessing some data field(s) in the user device 103, for the terminal module 101 to perform some validation(s). And so on.

In an operation of recharging a ticketing card, i.e. increasing the number of available trips, for example, the ticketing operation may be considered completed, at step 305, when a corresponding payment has been successfully processed and a data field representing the number of available trips has been accordingly updated in the user device.

Although only a number of examples have been disclosed herein, other alternatives, modifications, uses and/or equivalents thereof are possible. Furthermore, all possible combinations of the described examples are also covered. Thus, the scope of the present disclosure should not be limited by particular examples, but should be determined only by a fair reading of the claims that follow.

1. A method of performing a ticketing operation between a ticketing terminal and a user device having a device configuration, wherein:
the ticketing terminal comprises a terminal module, and
the user device comprises a memory having one or more data blocks each having one or more data fields;
the method comprising:
identifying the device configuration;
retrieving at the terminal module one or more abstract instructions of access to an abstract user device for performing the ticketing operation;
retrieving from a secure module one or more specific instructions of access, depending on the identified device configuration, to the user device for performing the abstract access instructions;
performing the abstract access instructions by executing the specific access instructions and thereby performing the ticketing operation.

2. A method according to claim 1, wherein the abstract instructions of access to the abstract user device are independent of the device configuration.

3. A method according to claim 1, wherein the specific access instructions are configured based on one or more specific access conditions.

4. A method according to claim 3, wherein the specific access conditions are dependent on the device configuration.

5. A method according to claim 3, wherein one or more of the specific access conditions are defined at the level of data field.

6. A method according to claim 3, wherein one or more of the specific access conditions comprise using a cryptographic key to be validated for access to a corresponding data field.

7. A method according to claim 6, wherein using the cryptographic key comprises signing at least part of a corresponding specific access instruction with the cryptographic key.

8. A method according to claim 6, wherein using the cryptographic key comprises an authentication between the ticketing terminal and the user device based on the cryptographic key.

9. A method according to claim 6, wherein the cryptographic key is the same cryptographic key for accessing different data fields of different data blocks of the user device's memory.

10. A method according to claim 9, wherein the cryptographic key is the same cryptographic key for accessing any data field of any data block of the user device's memory.

11. A method according to claim 3, wherein one or more of the specific access conditions comprise encrypting at least partially a corresponding specific access instruction.

12. A method according to claim 1, wherein identifying the device configuration comprises:
the terminal module receiving from the user device an identifier of the user device;
the terminal module sending the identifier to the secure module for the secure module to identify the device configuration.

13. A method according to claim 1, wherein retrieving the abstract access instructions at the terminal module comprises the terminal module retrieving the abstract access instructions according to one or more abstract ticketing rules.

14. A method according to claim 13, wherein the abstract ticketing rules are independent of the device configuration.

15. A method according to claim 1, wherein the abstract access instructions are comprised in a single set of abstract access instructions; and wherein the terminal module retrieving the abstract access instructions comprises the terminal module retrieving the abstract access instructions from the single set of abstract access instructions.

16. A method according to claim 1, wherein retrieving the specific access instructions from the secure module for performing the abstract access instructions comprises:
the terminal module sending to the secure module the abstract access instructions for the secure module to retrieve the specific access instructions for performing the abstract access instructions;
the terminal module receiving from the secure module the specific access instructions.

17. A method according to claim 16, wherein the specific access instructions are comprised in a set of specific access instructions of a plurality of sets of specific access instructions, each of the sets being dependent on a different device configuration; and wherein the secure module retrieving the specific access instructions comprises:
the secure module determining the set of specific access instructions depending on the device configuration;
the secure module retrieving the specific access instructions from the set of specific access instructions.

18. A method according to claim 1, wherein performing the abstract access instructions by executing the specific access instructions comprises:
the terminal module sending to the user device the specific access instructions for the user device to produce corresponding responses to the specific access instructions;
the terminal module receiving from the user device the responses to the specific access instructions;
the terminal module sending to the secure module the responses to the specific access instructions for the secure module to produce corresponding responses to the abstract access instructions based on at least some of the responses to the specific access instructions; and
the terminal module receiving from the secure module the responses to the abstract access instructions.

19. A ticketing terminal for performing a ticketing operation between the ticketing terminal and a user device having a device configuration, wherein:
the ticketing terminal comprises a terminal module;
the user device comprises a memory having one or more data blocks each having one or more data fields; and
the ticketing terminal is configured to perform a method of performing a ticketing operation according to claim 1.

20. A ticketing terminal according to claim 19, wherein the secure module comprises a secure access module (SAM) and/or a hardware security module (HSM).

21-24. (canceled)
